(19) United States
(12) Patent Application Publication
(10) Pub. No.: US 2004/0256519 A1
(43) Pub. Date: Dec. 23, 2004

(54) System for recovery of aerial vehicles

(76) Inventors: Stephen C. Ellis, Lexington, MA (US); Jerome P. Fanucci, Lexington, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/800,131

(22) Filed: Mar. 12, 2004

Related U.S. Application Data
(60) Provisional application No. 60/454,137, filed on Mar. 12, 2003.

(51) Int. Cl. B64C 7/00

(52) U.S. Cl. 244/110 E

(57) ABSTRACT

An aerial vehicle recovery system includes a landing pad secured or securable to a supporting surface. The landing pad has an upwardly facing capture surface having a passive retaining medium thereon. The aerial vehicle to be recovered includes one or more shoes affixed to a lower portion of the aerial vehicle. The shoes have a complementary passive retaining medium thereon configured to mate or interlock with or adhere to or otherwise interface with the retaining medium of the capture surface on the landing pad. The retaining medium on the landing pad and the complementary retaining medium on the aerial vehicle together form a passive retaining system that retains the vehicle on the landing pad upon the exertion of sufficient compressive force by the vehicle on the capture surface. The aerial vehicle recovery system can be used in conjunction with a variety of supporting surfaces, such as a ship's deck, an offshore platform, a truck bed, or the ground.

### CROSS REFERENCE TO RELATED APPLICATIONS

This application claims the benefit under 35 U.S.C. § 119(e) of U.S. Provisional Patent Application No. 60/454,137, filed Mar. 12, 2003, the disclosure of which is incorporated by reference herein.

### STATEMENT REGARDING FEDERALLY SPONSORED RESEARCH OR DEVELOPMENT

This application was made with Government support under SBIR Grant Contract No. N00167-02-C-0036. The Government may have certain rights in the invention.

### BACKGROUND OF THE INVENTION

Unmanned aerial vehicles (UAVs) can be used for a number of applications. UAVs can take many forms, such as a helicopter or an aircraft capable of vertical take-off and landing. UAVs that land on movable or moving surfaces, such as a ship's deck, benefit from a capture or recovery system that retains the UAV to the surface upon landing.

A known capture system for a UAV landing vertically onto a ship employs a 2,000 pound, 6 foot diameter steel grid that must be assembled by a crew on the ship's deck. A 100 pound socket that matches the steel grid is mounted on the undersurface of the UAV. The socket mechanically locks onto the steel grid upon landing. After removal of the UAV, the steel grid must be disassembled by the crew and stowed away. Both the steel grid and the socket on the UAV of this system are extremely heavy. The grid is difficult to handle and to stow and requires the labor of a number of crew members. The weight of the socket adds to the total weight of the UAV, reducing the weight allocation of the payload. For heavy aircraft, this penalty may not be significant, but it becomes significant for aircraft that are small and lightweight.

### SUMMARY OF THE INVENTION

The present invention provides a recovery system for an aerial vehicle, particularly a lightweight, unmanned aerial vehicle. The recovery system incorporates a landing pad having a capture surface with a passive retaining medium thereon and a complementary passive retaining medium on the aerial vehicle. The complementary retaining medium on the vehicle mates or interlocks with or otherwise interfaces with the passive retaining medium of the capture surface upon contact to retain the aerial vehicle upon the landing pad. The retaining media together form a passive retaining system, such as, for example, resilient interlocking stems or hook-to-hook or hook and loop fasteners. The landing pad may also include load carrying members that transfer the securing forces to the supporting surface to which the landing pad is secured.

The aerial vehicle recovery system can be used in conjunction with a variety of supporting surfaces, such as a ship's deck, an offshore platform such as an oil drilling platform, a truck bed, or the ground. The landing pad is secured, either removably or permanently, to the supporting surface. The retaining medium on the aerial vehicle is releasable from the vehicle to allow the vehicle to be removed from the landing pad, leaving the retaining medium attached to the capture surface.

The recovery system includes a transport cart for the landing pad in or upon which the landing pad can be stowed for storage and transport to and from the landing site. The recovery system also includes a cart upon which the aerial vehicle can be transported. After the aerial vehicle has landed safely, the cart is brought to the landing site, and the vehicle is detached from the retaining medium and lifted onto the cart. The cart with the vehicle thereon is then transported to a suitable storage location.

The present invention provides an aerial vehicle recovery system having hardware components on the aerial vehicle that are relatively light weight, are aerodynamic, are mechanically simple, and are simple to use. Similarly, the landing pad capture system components are relatively light in weight, are easily transported and prepared for use by a one or a small number of crew members, provide some shock absorbing characteristics to the aerial vehicle, are easily stored, are mechanically simple, and are simple to use.

The passive retaining media that interface between the aerial vehicle and the landing pad are capable of immediately securing the vehicle upon contact with the landing pad capture surface without power or other intervention, either manual or automated. The recovery system simplifies transport of the aerial vehicle to and from the landing site and is compatible with a wide variety of aerial vehicles.

### DESCRIPTION OF THE DRAWINGS

The invention will be more fully understood from the following detailed description taken in conjunction with the accompanying drawings in which:

FIG. 1 is a schematic perspective view of an aerial vehicle recovery system of the present invention;

FIG. 2 is a partial view of a base of the landing pad of FIG. 1;

FIGS. 3A-3F are sequential views of an aerial vehicle landing on the landing pad of the present invention;

FIG. 4 is an isometric view of a clamp-on fitting for the landing pad;

FIG. 5 is a partial view of a joint fitting for joining landing pad sections;

FIG. 6 is a further view of landing pad sections joined by joint fittings;

FIG. 7 illustrates a further embodiment of a landing pad of the present invention;

FIG. 8 illustrates a still further embodiment of a landing pad of the present invention;

FIG. 9 illustrates a shoe according to the present invention;

FIG. 10 illustrates a further embodiment of a shoe according to the present invention;

FIG. 11 is a perspective view of an aerial vehicle transport cart according to the present invention;

FIG. 12 is a perspective view of a further embodiment of an aerial vehicle transport cart according to the present invention; and

FIG. 13 is a schematic side view of interlocked passive engagement components.

### DETAILED DESCRIPTION OF THE INVENTION

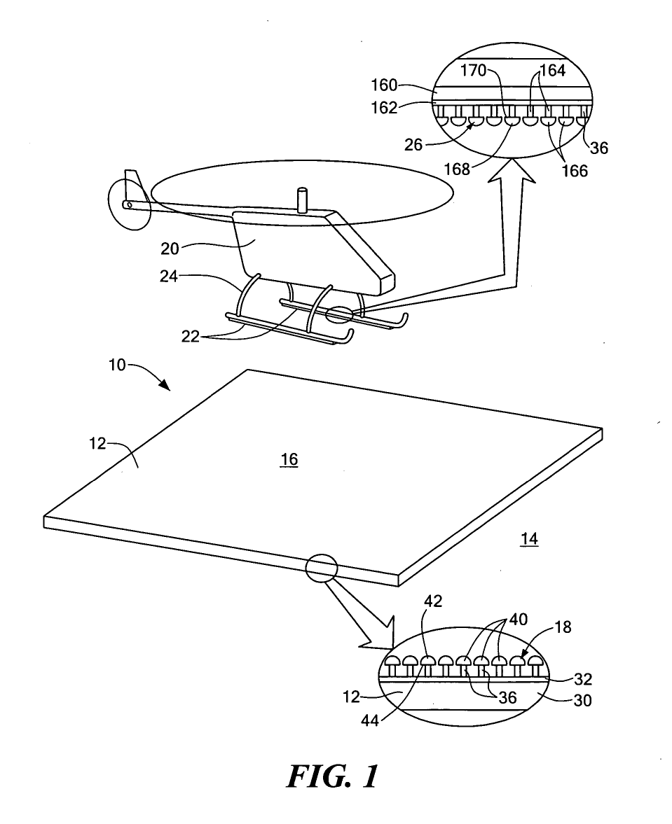

Referring to FIG. 1, an aerial vehicle recovery system 10 according to a preferred embodiment of the present invention includes a landing pad or mat 12 secured or securable to a supporting surface 14. The landing pad has an upwardly facing capture surface 16 having a passive retaining medium such as an engagement component 18 thereon. The aerial vehicle 20 to be recovered includes one or more shoes 22 removably or permanently affixed to a lower landing element 24 of the aerial vehicle. The shoes have a complementary passive retaining medium such as an engagement component 26 thereon configured to mate or interlock with or adhere to or otherwise interface with the engagement component 18 of the capture surface 16 on the landing pad 12 to retain the aerial vehicle on the capture surface.

The engagement component 18 on the landing pad and the complementary engagement component 26 on the aerial vehicle together form a passive retaining system that retains the vehicle on the landing pad upon the exertion of sufficient compressive force by the vehicle on the capture surface, such as the force exerted by the vehicle landing on the landing pad, without crushing of the engagement components. The engagement force is the amount of force necessary for the two components to mate. The disengagement force is the load holding capacity of the retaining system. The capture surface must also be sufficient to withstand loads such as crew members walking thereon and equipment rolling thereon without crushing.

The aerial vehicle recovery system can be used in conjunction with a variety of supporting surfaces, such as a ship's deck, an offshore platform, a truck bed, or the ground. The conditions under which the aerial vehicle must land on the supporting surface may be variable. For example, the supporting surface may be moving at the time the aerial vehicle is landing. A ship's deck may be moving with a deck displacement in both pitch and roll. Similarly, a truck bed may be stationary, preferably fixed or tied down to the ground, or traveling along a road. Wind may be blowing. The aerial vehicle rotor, if it has one, may be engaged. Thus, the retaining system must be able to capture the aerial vehicle at various angles of attack and landing speeds.

In a preferred embodiment, the landing pad 12 includes a base 30 having a planar configuration to which the capture surface 16 is affixed. The landing pad can be formed with any desired dimensions, depending on the type of aerial vehicle to be recovered. The landing pad can be rectangular, circular, octagonal, or any other configuration. The capture surface includes a substrate 32 that supports the engagement components 18. The substrate is affixed to an upper surface of the base in any suitable manner, such as by adhesive, stitching, RF welding, or any other manner of affixation, as would be known in the art. The substrate can also be integrally formed with the base.

The engagement component 18 and complementary engagement component 26 are in the form of a fastener material having self-engaging fasteners, such as interlocking stems or hook-to-hook or hook and loop fasteners. In the embodiment illustrated, the self-engaging fasteners include a plurality of closely spaced stems having stalks 36 extending from the substrate 32 and terminating with a hook 40, such as a widened cap having a curved outer surface 42 and a flat annular shoulder 44 beneath. The stems are approximately 2 mm tall. They can extend perpendicularly from the substrate or at an angle thereto. When the complementary engagement component 26 of the vehicle 20 is pressed onto the capture surface, the caps of the stems pass each other and the stems interlock. See FIG. 13. In this manner, the vehicle can be held to the landing pad.

The density of the stems on the substrate must be sufficient to generate an adequate holding force and to support the required loads while not requiring excessive engagement force. Thus, stem density is a trade-off between the impact force required to engage the fasteners, the holding power needed, and the crush resistance of the stems. Any suitable stem pattern may be used. The engagement and disengagement forces are also dependent on the area of fastener material. The parameters of stem density and area of fastener material are chosen based on size and weight of the aerial vehicle and the securing requirements. For example, a helicopter-style aerial vehicle requires a greater securing force on a ship than on a stationary platform due to the aerodynamic forces generated by the rotor due to rolling and pitching. It will also be appreciated that the present system is not suitable for aerial vehicles that are so heavy that the engagement components would be crushed.

The engagement components are preferably formed from an elastomeric material. A polyolefin material is suitable, as it also provides good environmental properties, such as moisture resistance, ultraviolet light resistance, and no apparent degradation upon exposure to common solvents such as gasoline, jet fuel, motor oil, acetone, and methyl ethyl ketone (MEK). This material retains its properties within a temperature range of −20° F. to 2200F. Suitable interlocking material is commercially available, such as DUAL LOCK™ available from Minnesota Mining and Manufacturing (in stem densities of 170 stems/inch², 250 stems/inch², and 400 stems/inch²), and brand HTH 858 available from Velcro (available in a stem density of 600 stems/inch²).

Other types of passive retaining media are contemplated by the invention. For example, the retaining medium may comprise a sticky medium such as a double-sided tape, putty, or adhesive. Similarly, the complementary retaining medium on the aerial vehicle may comprise a sticky medium such as a doubled-sided tape, putty, or adhesive. It will be appreciated that the landing element of the aerial vehicle should present a medium or surface that is capable of being retained on the retaining medium of the landing pad.

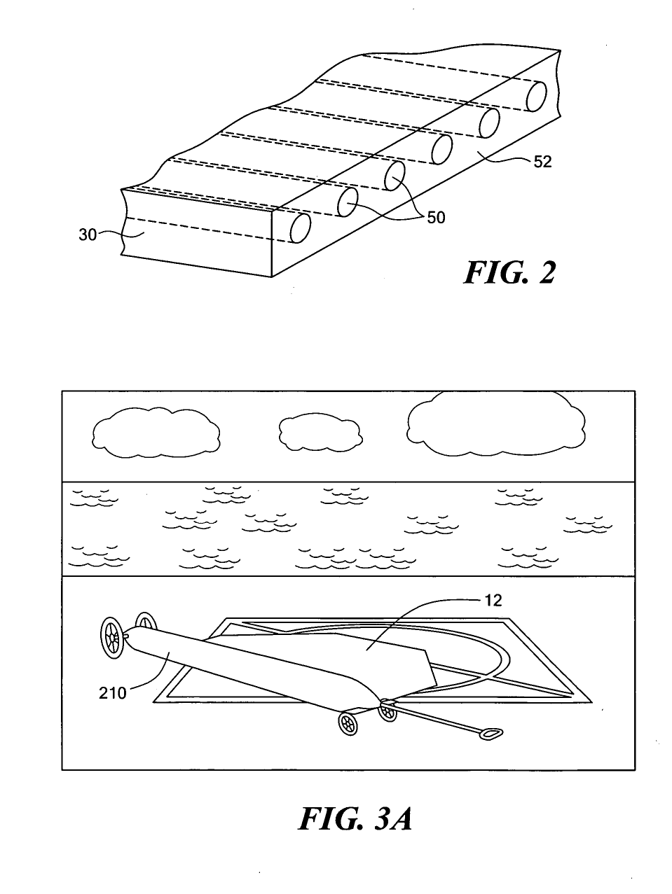

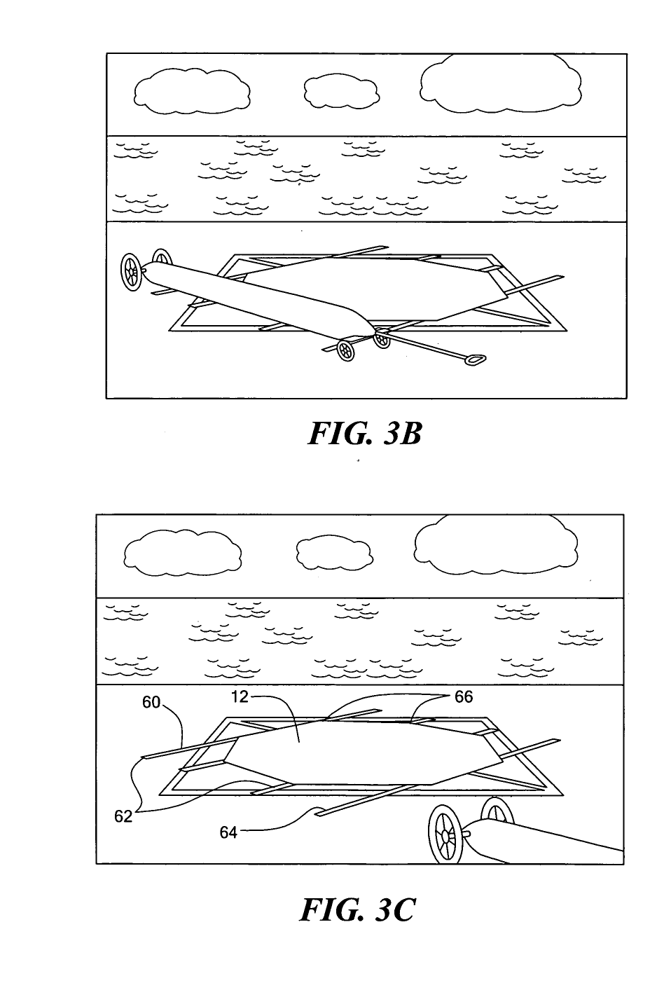

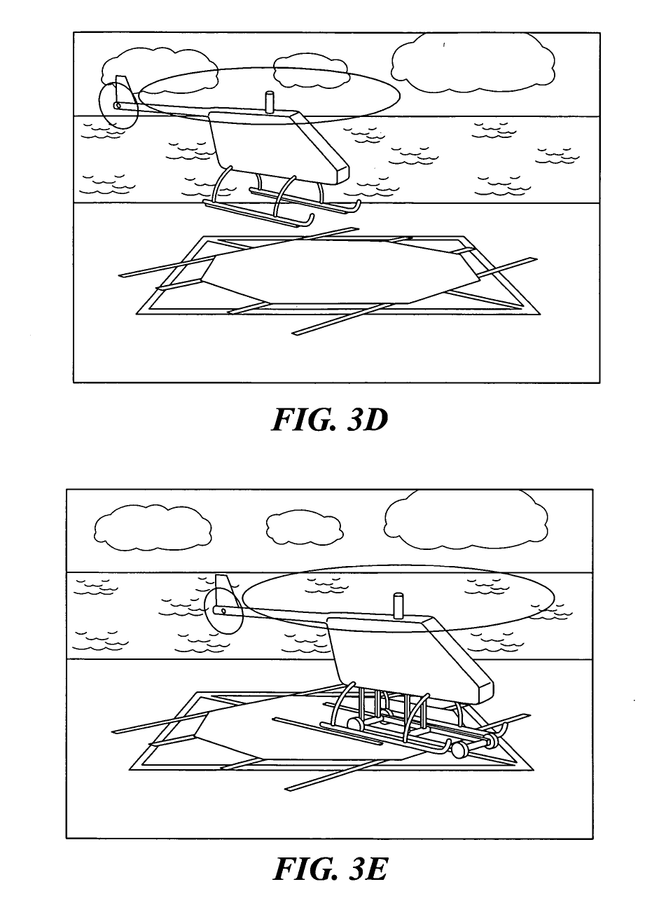

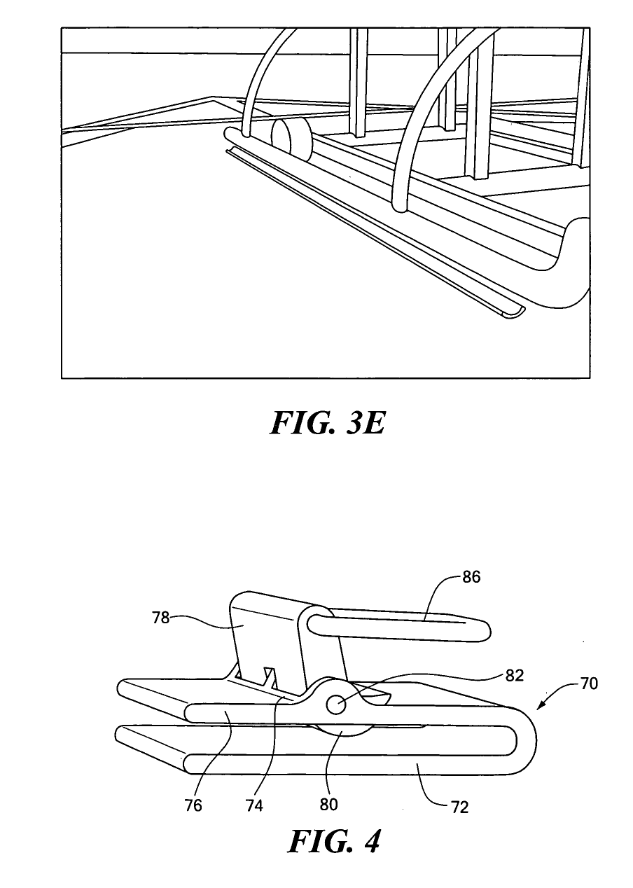

The base 30 of the landing pad is preferably a composite material having load carrying members 50 such as slender rods embedded in a matrix material 52. See FIG. 2. The load carrying members, in conjunction with a securing system, described further below, transmit the securing forces to the supporting surface 14. The rods can be of any suitable material, such as fiberglass. The matrix material similarly can be any suitable material, such as a flexible polyurethane. Use of a flexible, resilient matrix material provides some degree of impact force mitigation for the aerial vehicle upon landing. The load carrying members can all be oriented unidirectionally, which allows the pad to be rolled up, carpet-like, or folded for storage. The pad can be rolled with the engagement component facing inwardly or outwardly. The load carrying members can also be oriented in any other suitable manner that allows the mat to be folded if desired. In an alternative embodiment, the load carrying members can be flexible straps of nylon web embedded in or otherwise affixed to the base of the landing pad (FIG. 3).

In one example, a 12′×12′ polyurethane pad having ⅛″ diameter fiberglass rods oriented unidirectionally and spaced 6 rods per inch and a pad thickness of ⅜″ can be rolled up to approximately one foot in diameter. Such a pad weighs between 150 to 180 pounds, depending on the density of the fiberglass rods. The pad can be rolled up on a spool having a length to fit the longest dimension of the pad.

The landing pad can be secured, either removably or permanently, to a number of supporting surfaces, such as a ship's deck, an offshore platform, a truck bed, or the ground. For a removable system, the recovery system includes a securing system 60 to firmly affix the landing pad 12 via the load carrying members to the supporting surface. See FIG. 3. For example, a ship's deck may include tie down or hold down attachment points 62 to which ropes, straps, or other fastening devices 64 can be attached. Fittings 66 are provided at suitable points affixed on the edge of the landing pad to the load carrying members. The fittings can include rings, loops, eyes, or other attachment components to which ropes, straps, or other fastening devices are also attached. In this manner, tension loads from the tie down points are transferred via the fittings at the pad's edge. For a non-removable system, the landing pad can be integrally or permanently attached to or formed with the supporting surface, for example, a truck bed or ship's deck, for the dedicated purpose of aerial vehicle recovery.

If desired, the fittings may be removable so that they can be removed when the landing pad is to be rolled or folded and stowed. FIG. 4 illustrates one embodiment of a suitable removable fitting 70 including a clamp mechanism. A U-shaped member 72 slides onto the edge of the mat and over a number of the flexible rods. A slot 74 is formed through the upper leg 76 of the U-shaped member. A grip 78 is pivotably mounted on the upper leg at pivot points 82. A lower gripping surface 80 of the grip extends through the slot to press onto the upper surface of the landing pad and the rods when the grip is rotated upwardly, as shown in FIG. 4. A ring 86 is mounted to the upper end of the grip. A rope, strap, or other device is fastened between the ring and an existing tie down or hold down attachment point on the supporting surface.

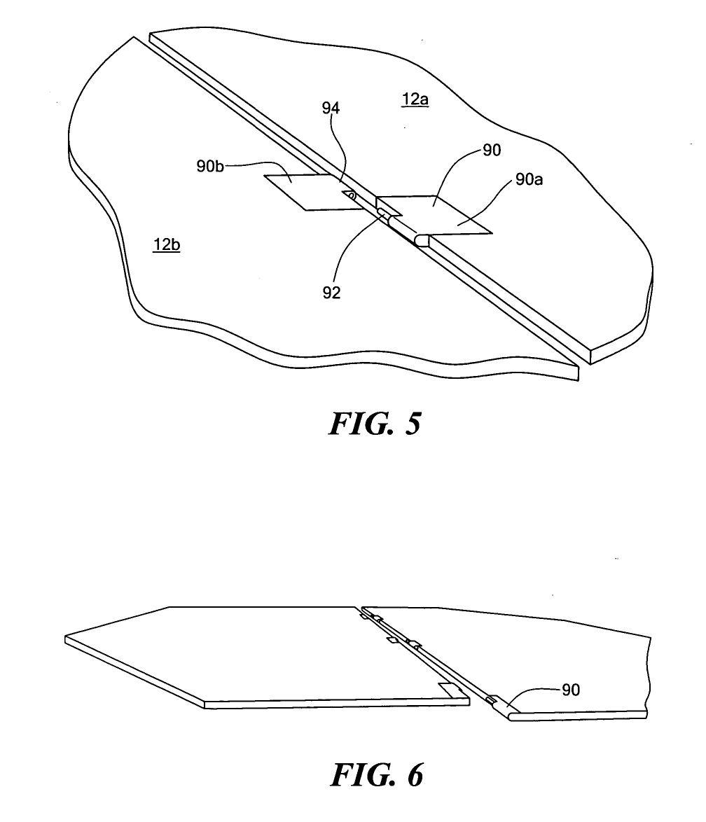

The area of the landing pad is determined by the accuracy of the automatic landing system of the aerial vehicle and the size of the landing gear of the aerial vehicle, which must contact the pad at all points. For example, a twelve-foot minimum length and width landing pad is suitable to provide sufficient area to capture a typical aerial vehicle. However, a shorter length or section size may be desirable for storage. In this case, the landing pad can be formed in two or more sections that are joined together when deployed. Additional joint fittings are required to join the sections. FIGS. 5 and 6 illustrate one embodiment of a suitable joint fitting 90. A pair of interconnecting fittings 90a, 90b, are affixed, permanently or removably, to edges of pad sections 12a, 12b that are to be deployed adjacent to each other. A hinge pin 92 extends from one fitting in the direction of the seam for sliding insertion into an aperture 94 in the adjacent fitting.

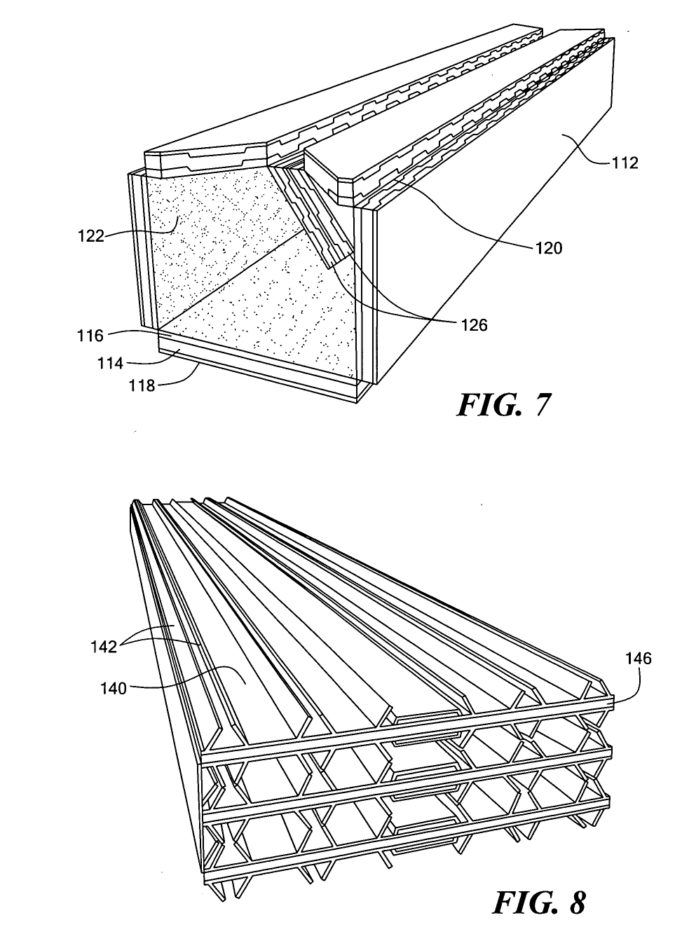

The landing pad can also be rigid or semi-rigid. An additional energy-absorbing layer may or may not be included. FIG. 7 illustrates a pad 112 having an energy absorbing layer 114 sandwiched between two rigid or semi-rigid panels 116, 118. The energy-absorbing layer can be made of any suitable material, such as a polyurethane. The panels can similarly be made of any suitable material, such as a composite material, metal, or wood. The mat is provided in sections that are hinged together along edges 120, so that the pad can be folded. In this embodiment, the load carrying members are preferably provided in the form of flexible straps, such as of nylon web, embedded in or otherwise affixed to the pad and extending transversely across the hinged joints. The straps extend beyond the pad's edges to fasten to the existing attachment points on the supporting surface. The capture surface 122 is provided on one panel 116 of the two panels. Because the capture system is self-engaging, the pad is preferably folded in such a manner that portions of the capture system do not contact other portions of the capture system. Thus, the pad is folded into a box-like structure with the capture surface facing inwardly. Outer strips 126 of the pad can be folded inwardly into the box-like structure to further minimize the size. Using this folding configuration, a 12′×12′ pad can be folded into a volume approximately 3′×4′×12′. Such a pad weighs generally between 1000 and 1200 pounds. Thus, this pad is more bulky and heavy than a similar sized pad in the flexible, rollable configuration described above.

A further embodiment is illustrated in FIG. 8. This pad includes a rigid or semi-rigid panel 140. Energy-absorbing legs 142 are affixed to one side of the panel. The legs can be made of any suitable material, such as a polyurethane. The panel can similarly be made of any suitable material, such as a composite material, metal, or wood. The panel is provided in sections that are hinged together. The load carrying members are similarly provided as flexible straps affixed to, embedded in, or otherwise attached the panels 140 in any suitable manner. In the embodiment illustrated, the pad is folded into a more compact configuration than the box-like structure shown in FIG. 7. However, the engagement components 146 on adjacent sides self engage, making deployment of the pad more difficult and time consuming.

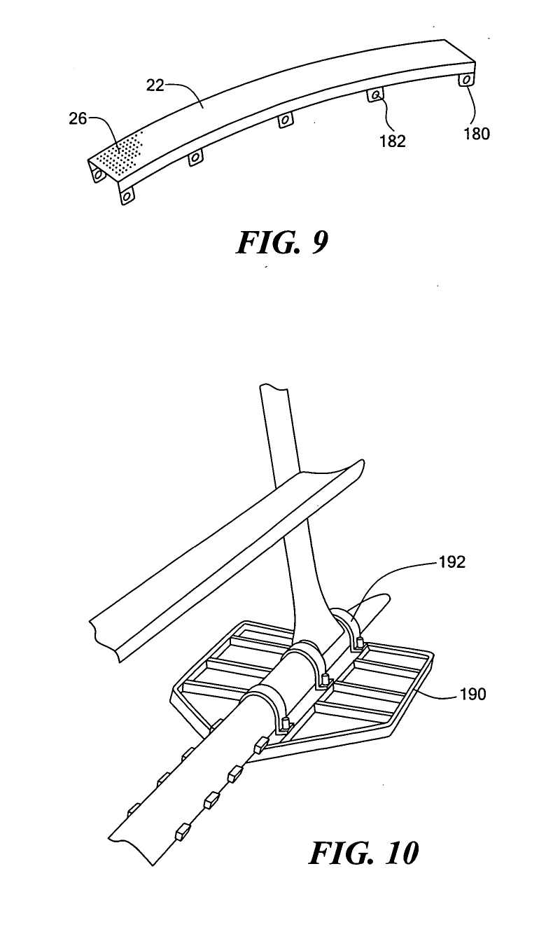

Referring to the embodiment illustrated in FIGS. 1 and 9, one or more shoes 22 are attached to the landing elements 24, such as landing gear or skids, of the aerial vehicle. The shoe or shoes can also be attached to existing skid shoes that may be provided for wear protection of the skids, as is known in the art. In the embodiment illustrated, the shoe includes a base 160 to which the complementary engagement component 26 is affixed. The complementary engagement component includes a substrate 162 and a plurality of closely spaced stems having stalks 164 extending from the substrate and terminating with a hook 166, such as a widened cap having a curved outer surface 168 and a flat annular shoulder 170 beneath. The fastener material must be able to support the weight of the aerial vehicle without crushing prior to and at takeoff. It must also provide the required holding force upon landing on the landing pad without requiring an excessive force to engage the engagement component of the landing pad. Stem density of the shoes can be the same as or can differ from the stem density of the capture surface on the landing pad. The substrate 162 is affixed to an outward surface of the base 160 in any suitable manner, such as by adhesive, stitching, RF welding, or any other manner of affixation, as would be known in the art. The aerial vehicle engagement component includes sufficient surface area so that enough fastener material can be installed to generate the required securing forces.

Preferably, the aerial vehicle shoes include a releasable fastening system to impart the capability of releasing the shoes from the vehicle after the aerial vehicle has landed on the landing pad. The shoes remain secured to the landing pad while the vehicle is removed from the landing pad. The shoes can be subsequently removed from the landing pad, such as by peeling the shoes from the capture surface.

In the embodiment of FIG. 9, the base of the aerial vehicle shoe is formed with a shape that conforms to an existing skid on an aerial vehicle. In this case, the skid is elongated with a slight curvature, so the base is similarly elongated and curved along its length. The shoe also protects the bottom surface of the skid. The base can be rigid or semi-rigid and preformed in the shape of the skid. The base can be formed of any suitable material, such as a composite material, wood, or a metal, such as aluminum, for the desired strength and rigidity. Alternatively, the base can be flexible to wrap about the skid during installation. The base can be formed by extrusion, pultrusion, or any other suitable manner, as would be known in the art. Any suitable fastening system to attach the shoe to the skid may be provided. Preferably, a quick release system is used. As illustrated in FIG. 9, the base may include pairs of opposed tabs 180 that extend circumferentially up both sides of the skid. Openings 182 in the tabs allow a strap or other device to be fastened thereto to retain the shoes to the skid.

In the further embodiment of FIG. 10, the base is formed as a rigid widened pad 190 that fastens to the skid. The widened pad provides additional surface area for the complementary engagement component. Any suitable fastening system such as quick release hose clamps 192 that wrap around the skids, can be provided.

In another embodiment, the passive retaining medium can be affixed directly to the landing elements, including landing gear, skids, or existing skid shoes, without an intervening base component. For example, an engagement component can be attached via adhesive, tape or any other suitable manner to the landing elements. The engagement component can also be disposable after use, such that once the aerial vehicle lands and has been removed from the landing pad leaving the engagement component behind, the engagement component can be removed from the pad and disposed of. New engagement components can be attached to the landing elements prior to each flight. As noted above, other forms of retaining media, for example, a sticky medium, can be provided, such as a double-sided tape, putty, or adhesive.

A landing pad transport cart 210 is provided to store the landing pad. See FIG. 3A. The cart includes a spool upon which the landing pad can be rolled. A winding mechanism is provided to wind or unwind the pad. The spool may be mounted within a housing for protection. Wheels are provided for moving the cart.

To use the cart, all fittings are preferably removed from the landing pad. One edge of the landing pad is attached to the spool in any suitable manner. The winding mechanism is actuated to roll the landing pad upon the spool. To deploy the landing pad, this process is reversed. The landing pad is unrolled from the spool. See FIG. 3A. The fittings are attached, and the landing pad is secured to the supporting surface, as discussed above. See FIGS. 3B, 3C.

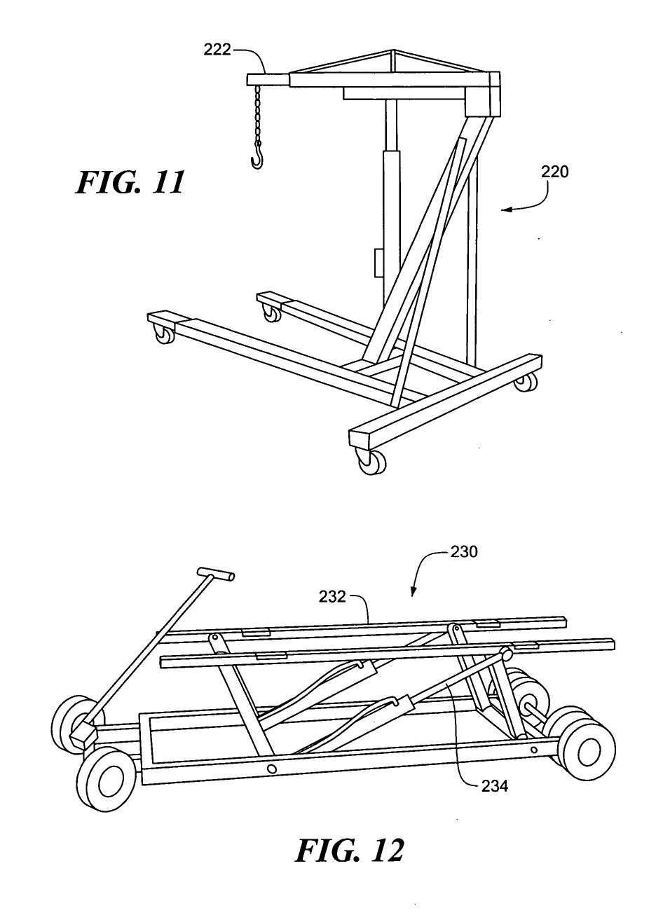

The present invention also provides a transport cart to move the aerial vehicle from a storage location such as a hangar and to return the aerial vehicle to the launch area for take off. The cart is designed for the particular aerial vehicle it is intended to handle. In one embodiment, illustrated in FIG. 11, the cart 220 includes a hoist mechanism 222 for lifting the vehicle onto a cradle. In another embodiment, illustrated in FIG. 12, the cart 230 includes a cradle 232 and jack mechanism 234. The cart is rolled under the vehicle so that the vehicle can be jacked onto the cradle.

The cart can be manually operated or powered in any suitable manner, such as with a battery. In another embodiment, the cart can be attached to a powered, continuous loop cable system arranged along the cart's course. One end of the cable is fixed at a base location, such as a hangar, and attached to a power supply. When the cart is powered by such a loop cable system, the cart remains attached and thus under control at all times, for example, if used on a pitching deck of a ship.

When the aerial vehicle lands and is retained on the landing pad capture surface, the cart can be brought from its storage location to pick up the vehicle. See FIGS. 3D, 3E, 3F. The fastening system holding the vehicle shoes to the vehicle skids is released. The vehicle is then free to be lifted, for example, by the hoist or jacks on the cart, off the landing pad capture surface and onto the cart. See FIG. 3F. The vehicle shoes remain fixed to the landing pad as described above and can be removed separately. The vehicle and the cart are then rolled off the landing pad. See FIG. 3F.

It will also be appreciated that the passive retaining medium on the aerial vehicle can be used alone without a landing pad if a suitable landing surface is available. For example, as noted above, the aerial vehicle can include a retaining medium comprising a double-sided tape, putty, adhesive or other sticky medium that can adhere to a surface such as concrete, a steel deck, a truck bed, or the ground.

The aerial vehicle recovery system of the present invention can be deployed and operated by a single person performing all tasks. Also, more than one person can be employed to perform various tasks simultaneously if desired. Alternatively, the system can be automated so that one or more tasks are performed under automation. The recovery system is suitable for lightweight aerial vehicles, for which a heavy prior art landing socket substantially limits the weight that can be allocated to the payload. The recovery system is particularly suitable for capture of an unmanned aerial vehicle.

The invention is not to be limited by what has been particularly shown and described, except as indicated by the appended claims.

What is claimed is:

1. An aerial vehicle recovery system comprising:
a landing pad configured to be supported on a supporting surface, the landing pad comprising an upwardly facing capture surface comprising a passive retaining medium; and
a shoe configured to be mounted to a landing element of an aerial vehicle, the shoe comprising a passive retaining medium configured to interface with the passive retaining medium of the landing pad to retain the aerial vehicle to the landing pad.

2. The system of claim 1, wherein the landing pad further comprises a base, and the passive retaining medium of the landing pad comprises a passive engagement component supported by the base.

3. The system of claim 2, wherein the passive engagement system component of the landing pad extends from a substrate supported by the base.

4. The system of claim 3, wherein the passive engagement system component of the landing pad comprises a plurality of stems extending from the substrate.

5. The system of claim 3, wherein the substrate is affixed to an upper surface of the base of the landing pad.

6. The system of claim 3, wherein the substrate is integrally formed with the base of the landing pad.

7. The system of claim 1, wherein the passive retaining medium of the landing pad comprises a passive engagement component.

8. The system of claim 1, wherein the passive retaining medium of the landing pad comprises a sticky medium.

9. The system of claim 1, wherein the passive retaining medium of the landing pad comprises a tape.

10. The system of claim 1, wherein the passive retaining medium of the landing pad comprises an adhesive.

11. The system of claim 1, wherein the passive retaining medium of the landing pad comprises a putty.

12. The system of claim 1, wherein the shoe further comprises a base and the passive retaining medium of the shoe comprises a passive engagement component supported by the base.

13. The system of claim 12, wherein the passive engagement system component of the shoe extends from a substrate supported by the base.

14. The system of claim 13, wherein the passive engagement system component of the shoe comprises a plurality of stems extending from the substrate.

15. The system of claim 13, wherein the substrate is affixed to a lower surface of the base of the shoe.

16. The system of claim 13, wherein the substrate is integrally formed with the base of the shoe.

17. The system of claim 1, wherein the passive retaining medium of the shoe comprises a passive engagement component.

18. The system of claim 1, wherein the passive retaining medium of the shoe comprises a sticky medium.

19. The system of claim 1, wherein the passive retaining medium of the shoe comprises a tape.

20. The system of claim 1, wherein the passive retaining medium of the shoe comprises an adhesive.

21. The system of claim 1, wherein the passive retaining medium of the shoe comprises a putty.

22. The system of claim 1, wherein the passive retaining medium of the landing pad and the passive retaining medium of the shoe comprise self-engaging fasteners.

23. The system of claim 1, wherein the passive retaining medium of the landing pad and the passive retaining medium of the shoe comprise hook and loop fasteners.

24. The system of claim 1, wherein the passive retaining medium of the landing pad and the passive retaining medium of the shoe comprise hook-to-hook fasteners.

25. The system of claim 1, wherein the passive retaining medium of the landing pad and the passive retaining medium of the shoe comprise stems each having a stalk terminating with a hook.

26. The system of claim 1, wherein the passive retaining medium of the landing pad and the passive retaining medium of the shoe comprise stems each having a stalk terminating with a cap.

27. The system of claim 1, wherein the passive retaining medium of the landing pad and the passive retaining medium of the shoe comprise an elastomeric material.

28. The system of claim 1, wherein the passive retaining medium of the landing pad and the passive retaining medium of the shoe comprise a polyolefin material.

29. The system of claim 1, wherein the landing pad further comprises a base including load carrying members operative to transfer a load on the landing pad to a supporting surface.

30. The system of claim 29, wherein the base of the landing pad comprises a composite material comprising the load carrying members embedded in a matrix material.

31. The system of claim 30, wherein the matrix material comprises a polyurethane material.

32. The system of claim 29, wherein the load carrying members are oriented unidirectionally.

33. The system of claim 29, wherein the load carrying members comprise a fiberglass material.

34. The system of claim 29, wherein the load carrying members comprise rods.

35. The system of claim 29, wherein the load carrying members comprise flexible straps.

36. The system of claim 1, wherein the landing pad is rollable.

37. The system of claim 1, wherein the landing pad is foldable.

38. The system of claim 1, wherein the landing pad is flexible.

39. The system of claim 1, wherein the landing pad is resilient.

40. The system of claim 1, wherein the landing pad is energy-absorbing.

41. The system of claim 1, wherein the landing pad further comprises a plurality of pad sections and one or more joint fittings configured to attach the plurality of pad sections together.

42. The system of claim 41, further comprising load carrying members extending transversely across joints between the pad sections.

43. The system of claim 41, wherein the joint fittings comprise hinged joint fittings.

44. The system of claim 41, wherein the joint fittings are removably affixed to the pad sections.

45. The system of claim 1, wherein the landing pad further comprises a plurality of pad sections and a joint attachment mechanism configured to attach the plurality of pad sections together.

46. The system of claim 1, wherein the landing pad further comprises a plurality of pad sections attached together along hinged joints.

47. The system of claim 46, wherein the hinged joints are integral with the pad sections.

48. The system of claim 46, wherein the hinged joints are permanently affixed to the pad sections.

49. The system of claim 46, wherein the hinged joints are removably affixed to the pad sections.

50. The system of claim 1, wherein the landing pad further includes an energy-absorbing layer.

51. The system of claim 1, wherein the landing pad further includes an energy-absorbing layer between two panels.

52. The system of claim 51, wherein the panels comprise panel sections, and the panel sections of one of the panels are attached together along hinged joints

53. The system of claim 51, wherein the panels are rigid.

54. The system of claim 51, wherein the panels are semi-rigid.

55. The system of claim 1, wherein the landing pad further comprises a panel having first and second sides and energy-absorbing legs affixed to the first side of the panel, and the passive retaining medium is supported by the second side of the panel.

56. The system of claim 55, wherein the panel comprises panel sections attached together along hinged joints.

57. The system of claim 1, wherein the landing pad further includes:
load carrying members operative to transfer a load on the landing pad to a supporting surface; and
a securing system in load transferring communication with the load carrying members and configured to affix the landing pad to a supporting surface.

58. The system of claim 57, wherein the securing system comprises fittings disposed along edges of the landing pad.

59. The system of claim 58, wherein the fittings are removably attachable along edges of the landing pad.

60. The system of claim 58, wherein the fittings comprise clamp mechanisms attachable along edges of the landing pad.

61. The system of claim 58, wherein the fittings are permanently affixed along edges of the landing pad.

62. The system of claim 57, wherein the securing system comprises fittings having rope or strap attachment components.

63. The system of claim 62, wherein the rope or strap attachment components comprise rings, loops, or eyes.

64. The system of claim 1, wherein the shoe is elongated from a front end to a back end and curved from the front end to the back end.

65. The system of claim 1, wherein the shoe further comprises a base, the passive retaining medium supported by the base.

66. The system of claim 65, wherein the base of the shoe comprises a flat pad.

67. The system of claim 65, wherein the base of the shoe is rigid.

68. The system of claim 65, wherein the base of the shoe is semi-rigid.

69. The system of claim 65, wherein the base of the shoe is flexible.

70. The system of claim 1, further comprising a fastening system configured to fasten the shoe to the lowermost landing element of the aerial vehicle.

71. The system of claim 70, wherein the fastening system comprises at least one pair of upwardly extending tabs on opposed sides of the shoe and a fastening element fastenable between the tabs of a pair of tabs.

72. The system of claim 70, wherein the fastening system comprises a hose clamp.

73. The system of claim 1, further comprising a transport cart configured to store and transport the landing pad.

74. The system of claim 1, further comprising a transport cart configured to transport the aerial vehicle.

75. The system of claim 74, wherein the transport cart includes a hoist mechanism configured to hoist the aerial vehicle onto the transport cart.

76. The system of claim 74, wherein the transport cart includes a jack mechanism configured to jack the aerial vehicle onto the transport cart.

77. The system of claim 1, wherein the landing pad is securable to a ship's deck.

78. The system of claim 1, wherein the landing pad is secured to a ship's deck.

79. The system of claim 1, wherein the landing pad is securable to a truck bed.

80. The system of claim 1, wherein the landing pad is secured to a truck bed.

81. The system of claim 1, wherein the landing pad is securable to an offshore platform.

82. The system of claim 1, wherein the landing pad is secured to an offshore platform.

83. The system of claim 1, wherein the landing pad is securable to ground.

84. The system of claim 1, wherein the landing pad is secured to ground.

85. A method for recovering an aerial vehicle using the recovery system of claim 1 comprising:
providing the landing pad on a support surface; and
landing the aerial vehicle with the shoe mounted on the lowermost landing element on the landing pad with the passive retaining medium of the landing pad and the passive retaining medium of the shoe in retention.

86. The method of claim 85, further comprising:
removing the shoe from the aerial vehicle while the vehicle is on the landing pad; and
removing the aerial vehicle from the landing pad, leaving the shoe engaged on the landing pad.

87. A method for recovering an aerial vehicle comprising:
providing a landing pad configured to be supported on a supporting surface, the landing pad comprising an upwardly facing capture surface comprising a passive retaining medium; and
landing the aerial vehicle on the landing pad, a landing element of the aerial vehicle retained by the passive retaining medium on the capture surface.

88. An aerial vehicle recovery system comprising:
an aerial vehicle having a landing element; and
a passive retaining medium mounted to the landing element and configured to retain the aerial vehicle on a landing surface.

89. The system of claim 88, wherein the passive retaining medium comprises a passive engagement component.

90. The system of claim 88, wherein the passive retaining medium comprises a hook-to-hook fastener.

91. The system of claim 88, wherein the passive retaining medium comprises a hook and loop fastener.

92. The system of claim 88, wherein the passive retaining medium comprises tape.

93. The system of claim 88, wherein the passive retaining medium comprises adhesive.

94. The system of claim 88, wherein the passive retaining medium comprises putty.

95. The system of claim 88, wherein the passive retaining medium is adhesively mounted to the landing element.

96. The system of claim 88, wherein the passive retaining medium is removably mounted to the landing element.

97. The system of claim 88, wherein the passive retaining medium is affixed to a shoe mounted to the landing element.

98. The system of claim 97, wherein the shoe is removably mounted to the landing element.

99. A method for recovering an aerial vehicle using the recovery system of claim 88, comprising:
landing the aerial vehicle with the passive retaining medium on the landing element of the aerial vehicle in retention with the landing surface.

100. The method of claim 99, wherein the landing surface comprises a ship's deck.

101. The method of claim 99, wherein the landing surface comprises a truck bed.

102. The method of claim 99, wherein the landing surface comprises an offshore platform.

103. The method of claim 99, wherein the landing surface comprises ground.

104. The method of claim 99, wherein the landing surface comprises a landing pad.

105. The method of claim 99, further comprising providing the landing surface with a passive retaining medium thereon.

106. The method of claim 105, wherein the landing surface has a hook and loop fastener thereon.

107. The method of claim 105, wherein the landing surface has a hook-to-hook fastener thereon.

108. The method of claim 105, wherein the landing surface has tape thereon.

109. The method of claim 105, wherein the landing surface has adhesive thereon.

110. The method of claim 105, wherein the landing surface has putty thereon.
